(19) United States
(12) Patent Application Publication
(10) Pub. No.: US 2010/0200202 A1
(43) Pub. Date: Aug. 12, 2010

(54) AUTOMOTIVE HEAT EXCHANGER EXTRUSION TUBE AND METHOD FOR MANUFACTURING THE SAME

(76) Inventors: Jong-Seo Yoon, Yongin-si (KR); Sang-Hun Lee, Yongsan-gu (KR); Jee-Yong Park, Seongnam-si (KR)

Correspondence Address: SHERR & VAUGHN, PLLC, 620 HERNDON PARKWAY, SUITE 320, HERNDON, VA, 20170, US

(21) Appl. No.: 12/641,396

(22) Filed: Dec. 18, 2009

(30) Foreign Application Priority Data
Feb. 10, 2009 (KR) 10-2009-0010669

(51) Int. Cl. F28F 1/02; B05D 5/00

(52) U.S. Cl. 165/177; 427/256

(57) ABSTRACT

An automotive heat exchanger extrusion tube includes a tube body; and a coating layer formed by applying a coating liquid containing silicon powder to an outer surface of the tube body, wherein the coating layer is formed only on a portion of the outer surface of the tube body and extends along the longitudinal direction of the tube body.

### TECHNICAL FIELD

The present invention relates to an automotive heat exchanger extrusion tube and a method for manufacturing the same, and in particular, to an automotive heat exchanger extrusion tube for discharging heat generated from a heat emitting component embedded in vehicles, and a method for manufacturing said automotive heat exchanger extrusion tube.

### BACKGROUND ART

Generally, a heat exchanger extrusion tube is used to discharge heat generated in vehicles. The heat exchanger extrusion tube includes an aluminum tube body formed by an extrusion method, and a coating layer formed on the tube body. The coating layer serves as an adhesive when a fin is attached to the surface of the heat exchanger extrusion tube. The coating layer is formed by applying a coating liquid containing silicon powder to the surface of the aluminum tube body. A connection between the fin and the heat exchanger extrusion tube is established by contacting the fin with the surface of the heat exchanger extrusion tube and applying heat to the contact part. When heat is applied to the contacted part, the coating layer melts and turns into liquid, and then the liquefied coating layer cures again and is attached to the surface of the heat exchanger extrusion tube.

A conventional heat exchanger extrusion tube is configured such that the coating layer is formed over upper and lower surfaces of the aluminum tube body. However, in the conventional heat exchanger extrusion tube, the coating layer turns into liquid too much when heat is applied to establish connection between a fin and the tube body, and excessive erosion occurs due to a chemical reaction between the liquefied coating layer and the aluminum tube body. As a result, a phenomenon occurs that a hole is formed partially on the surface of the aluminum tube body. Proper measures should be taken to prevent said phenomenon.

### DISCLOSURE

### Technical Problem

The present invention is designed to solve the above-mentioned problem, and therefore it is an object of the present invention to provide an automotive heat exchanger extrusion tube for preventing excessive erosion from occurring on the surface of a tube body when a fin is connected with the tube body. And, it is another object of the present invention to provide a method for manufacturing said automotive heat exchanger extrusion tube.

### Technical Solution

In order to achieve the above-mentioned object, an automotive heat exchanger extrusion tube according to the present invention comprises a tube body; and a coating layer formed by applying a coating liquid containing silicon powder to an outer surface of the tube body, wherein the coating layer is formed only on a portion of the outer surface of the tube body and extends along the longitudinal direction of the tube body.

Preferably, the outer surface of the tube body includes a flat upper surface and a flat lower surface facing opposite to the upper surface, the coating layer is formed on both the upper surface and the lower surface or any one of the upper surface and the lower surface, and a ratio of the area of the coating layer to the outer surface area of the tube body is 30% to 70%.

Preferably, the coating layer extends along the longitudinal direction of the tube body and is arranged at a predetermined interval relative to the latitudinal direction of the tube body.

A method for manufacturing an automotive heat exchanger extrusion tube according to another aspect of the present invention comprises (a) forming a tube body; and (b) forming a coating layer by applying a coating liquid containing silicon powder to an outer surface of the tube body, wherein, in the step (b), the coating layer is formed only on a portion of the outer surface of the tube body and extends along the longitudinal direction of the tube body.

Preferably, in the step (b), the outer surface of the tube body includes a flat upper surface and a flat lower surface facing opposite to the upper surface, the coating layer is formed on both the upper surface and the lower surface or any one of the upper surface and the lower surface, and a ratio of the area of the coating layer; to the outer surface area of the tube body is 30% to 70%.

Preferably, in the step (b), the coating layer extends along the longitudinal direction of the tube body and is arranged at a predetermined relative to the latitudinal direction of the tube body.

### DESCRIPTION OF DRAWINGS

FIG. 1 is a perspective view of an example of an automotive heat exchanger extrusion tube according to the present invention.

FIG. 2 is a perspective view of another example of an automotive heat exchanger extrusion tube according to the present invention.

### BEST MODE

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

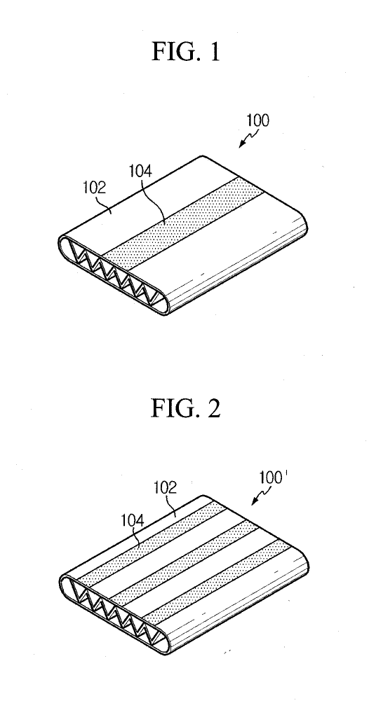

FIG. 1 is a perspective view of an example of an automotive heat exchanger extrusion tube according to the present invention. FIG. 2 is a perspective view of another example of an automotive heat exchanger extrusion tube according to the present invention.

As shown in FIG. 1, the automotive heat exchanger extrusion tube 100 according to the present invention includes a tube body 102 and a coating layer 104. The tube body 102 is made from aluminum or aluminum alloys, and formed by an extrusion method. The coating layer 104 is formed by applying a coating liquid containing silicon powder on at least one surface of an upper surface and a lower surface of the tube body 102 by a roll coating or spray method.

At this time, the coating layer 104 is formed by applying the coating liquid only to a portion of the outer surface of the tube body 102. Preferably, the tube body 102 has a flat upper surface and a flat lower surface facing opposite to the upper surface, and the coating layer 104 is formed on both the upper surface and the lower surface or any one of the upper surface and the lower surface.

Preferably, the coating layer 104 extends in the longitudinal direction of the tube body 102. In this case, the coating layer 104 turns into liquid due to heat applied to connect a fin with the surface of the tube body 102, and a proper amount of the coating liquid for connection is then coated on the tube body 102. Thus, it can prevent the surface of the tube body from excessively corroding due to a surplus coating liquid. That is, the liquefied coating layer 104 spreads in the latitudinal direction of the tube body 102 when the fin is connected with the tube body 102, and then the coating layer 104 is thinly formed on the surface of the tube body 102. In this case, a chemical reaction between the liquefied coating layer 104 and the tube body 102 does not concentrate on a specific spot but spreads over the wide area. Accordingly, it can prevent a phenomenon that a hole is formed on the surface of the tube body 102.

Meanwhile, a ratio of the area of the coating layer 104 to the outer surface area of the tube body 102 is preferably 30% to 70%. If the area of the coating layer 104 is too small, it is difficult to ensure a strong connection between the tube body 102 and the fin. If the area of the coating layer 104 is too large, a hole is formed in the surface of the tube body 102, which turns out at variance with the intention of the present invention. Thus, it is preferred that the area of the coating layer 104 is within said range.

Although the above-mentioned embodiment shows the automotive heat exchanger extrusion tube 100 comprising a single line of the coating layer 104 formed at the center of the surface of the tube body 102, the automotive heat exchanger extrusion tube 100 may be configured such that the coating layer 104 extends on the surface of the tube body 102 in the longitudinal direction of the tube body 102 and is arranged at a predetermined interval relative to the latitudinal direction of the tube body 102, as shown in FIG. 2.

Meanwhile, the coating liquid includes silicon powder, a flux, a binder, a solvent and other additives. And, the coating liquid may further include zinc (Zn) powder to improve corrosion resistance. The coating liquid may be prepared using a mixture of a chemically synthesized potassium(K)-silicon(Si)-fluorine(F)-based flux or a chemically synthesized potassium(K)-zinc(Zn)-fluorine(F)-based flux with a predetermined mixing ratio.

Hereinafter, a method for manufacturing the automotive heat exchanger extrusion tube according to the present invention is described with reference to FIGS. 1 and 2.

The manufacturing method of the present invention comprises (a) forming the tube body 102 by an extrusion method, and (b) applying a coating liquid containing silicon powder on a portion of the surface of the tube body 102 formed in the step (a) to form the coating layer 104. The coating liquid is applied on the surface of the tube body 102 by a roll coating or spray method.

In the step (b), the coating layer 104 extends in the longitudinal direction of the tube body 102. And, the coating layer 104 may be formed on both the upper surface and the lower surface of the tube body 102 or any one of the upper surface and the lower surface of the tube body 102.

And, the coating layer 104 is formed only at the center of the surface of the tube body 102 as shown in FIG. 1, or arranged on the surface of the tube body 102 at a predetermined interval relative to the latitudinal direction of the tube body 102 as shown in FIG. 2.

At this time, in the step (b), the coating layer 104 is formed such that a ratio of the area of the coating layer 104 to the outer surface area of the tube body 102 is 30% to 70%. The reason why the area of the coating layer 104 is limited to said range is as described above.

Meanwhile, although the specification of the present invention shows the tube body 102 formed by an extrusion method, the present invention is not limited to a specific technique for forming the tube body 102. This is obvious to those skilled in the art, and the detailed description is omitted herein.

### INDUSTRIAL APPLICABILITY

According to the present invention, the coating layer is formed only on a portion of the outer surface of the tube body, and thus, it can prevent a phenomenon that the surface of the tube body excessively corrodes due to a surplus coating liquid during a brazing process, occurred in the case that a coating layer is formed over the entire outer surface of a tube body. As a result, it prevents a hole from forming in the tube body when the fin is connected with the tube body during the brazing process.

1-6. (canceled)

7. An automotive heat exchanger extrusion tube, comprising:
a tube body; and
a coating layer formed by applying a coating liquid containing silicon powder to an outer surface of the tube body,
wherein the coating layer is formed only on a portion of the outer surface of the tube body and extends along a longitudinal direction of the tube body.

8. The automotive heat exchanger extrusion tube according to claim 7,
wherein the outer surface of the tube body includes a flat upper surface and a flat lower surface facing opposite to the upper surface,
wherein the coating layer is formed at least one of the upper surface and the lower surface or any one of the upper surface and the lower surface, and
wherein a ratio of the area of the coating layer to the outer surface area of the tube body is in a range between 30% and 70%.

9. The automotive heat exchanger extrusion tube according to claim 7,
wherein the coating layer extends along the longitudinal direction of the tube body and is arranged over a plurality of discrete regions spaced at a predetermined interval relative to the latitudinal direction of the tube body.

10. A method for manufacturing an automotive heat exchanger extrusion tube, comprising:
(a) forming a tube body; and
(b) forming a coating layer by applying a coating liquid containing silicon powder to an outer surface of the tube body,
wherein, in the step (b), the coating layer is formed only on a portion of the outer surface of the tube body, and extends along a longitudinal direction of the tube body.

11. The method for manufacturing an automotive heat exchanger extrusion tube according to claim 10,
wherein, in the step (b), the outer surface of the tube body includes a flat upper surface and a flat lower surface facing opposite to the upper surface,
wherein the coating layer is formed on at least one of the upper surface and the lower surface, and
wherein a ratio of the area of the coating layer to the outer surface area of the tube body is in a range between 30% and 70%.

12. The method for manufacturing an automotive heat exchanger extrusion tube according to claim 10,
wherein, in the step (b), the coating layer extends along the longitudinal direction of the tube body and is arranged over a plurality of discrete regions spaced at a predetermined interval relative to the latitudinal direction of the tube body.
